(19) United States
(12) Patent Application Publication
(10) Pub. No.: US 2002/0177112 A1
(43) Pub. Date: Nov. 28, 2002

(54) Systems and methods for enhancing language communication in babies and children of all ages

(76) Inventor: Lora F. Heller, New York, NY (US)

Correspondence Address: Rashida A. Karmali, 99 Wall Street, New York, NY, 10005, US

(21) Appl. No.: 09/801,444

(22) Filed: Mar. 8, 2001

Related U.S. Application Data
(60) Provisional application No. 60/227,114, filed on Aug. 22, 2000.

(51) Int. Cl. G09B 19/00; G09B 5/00

(52) U.S. Cl. 434/308

(57) ABSTRACT

Systems and methods for enhancing communications between grown-ups and babies as young as one month, children in pre-school and toddlers anywhere in-between and for the hearing impaired, are provided using a unique combination of American Sign Language and music. The signing is expressed using movements of the baby's fingers and music is in the form of signing and/or rhythmic instrumental play. The systems comprise of a range of curricula, a clothing line, books, games and toys and children's television shows as methods to enhance communication between babies and grown-ups. The systems and methods of the present invention promote communication, increase the I.Q., improve vocabulary, decrease frustration, refine motor coordination and develop spatial reasoning skills.

### 1. CROSS-REFERENCE TO RELATED APPLICATION

This application is a Continuation-in-Part of co-pending application entitled “Systems and Methods for Enhancing Language Development In Babies and Children” (U.S. application Ser. No. 60/227,114 filed on Aug. 22, 2000).

### 2. BACKGROUND OF THE INVENTION

The use of signing for communication with the hearing impaired is well-known and established, primarily among the deaf community. For the hearing impaired, language is conveyed visually. There has been some effort to adapt the standard mass media such as television for comprehension by the hearing impaired, for example, for providing the words in sign language, showing only the upper half of the person signing in one corner of the screen. Moreover, visual language development is deaf infants is undertaken by exposing them to a formal sign system, such as the American Sign Language (ASL).

However, heretofore, there is not prior art method for hearing infants and children to use a formal sign system to enhance their language development and communication skills.

### 3. SUMMARY OF THE INVENTION

This invention relates generally to systems and methods for using sign language and/or music to enhance language development and communication skills in hearing infants as well as in deaf infants, starting from four to six weeks of life to pre-school age.

The present invention provides a unique system by which to enhance and develop the precursors of auditory and visual language observed in infants to manifest value of speech and comprehension. Precursors of visual language, hearing and deaf infants include gestures, and they initiate various gestures to make their needs known. Precursors of auditory language are produced by hearing infants in the form of a sequence of prelinguistic utterances and sounds. The present invention provides a system to integrate the precursors of auditory utterances with visual gestures and enhances the communication between the infant and the caretaker. Sign language training in infants boots the I.Q. by an average of 12 points, accelerates verbal language acquisition and helps to enrich communication between parents and babies.

In yet another embodiment of the present invention, the system includes exposure to music and signing that enhances auditory expression and receptive ability in the infant, and in particular improves spatial reasoning skills, enhances complex math and geometric skills and reinforces language development. In preferred embodiments of the invention, the system comprises of a plurality of curricula developed specifically for specific age groups including, but not limited to, infants from the age of four weeks of life to children of ten years of age.

The present invention is designed to be used with the aid of various caretakers, including parents, teachers, pediatric specialists, or day care attendants.

### 4. DETAILED DESCRIPTION OF THE PREFERRED EMBODIMENTS

Babies as young as one month, children in pre-school, and toddlers anywhere in-between benefit from the systems and methods of the present invention which combine the use of the American Sign Language and music. Based on considerable amount of research, the present system, also referred to as “Baby Fingers”, is designed to promote communication between the infant and the caregiver, to enhance motivation to speak, increase the I.Q., improve vocabulary, decrease frustration (as a result of better comprehension), and refine motor coordination and special reasoning skills. The system provides sign language instruction through music for parents and their children.

Human infants produce a uniform sequence of prelinguistic utterances, regardless of the language spoken by their adult caregivers. The earliest of these utterances (4-6 weeks of age) is cooing, which consists of musical, open vowel sounds. This is followed in the first few months of life by bilabial sounds. By 5 months, laughing and a variety of monosyllables (“ba” or “ga”) appear. Between 6 and 8 months, infants produce polysyllabic babbling (“lalalala”, “mamma”). By 9 months infants produce the truncated utterances “mama” or “dada”. Vocabulary growth velocity accelerates steadily from the second year on. Along with increased linguistic complexity comes increased intelligibility (clarity of speech) which is essentially complete by age 4 years.

The various stages of language development of the invention are summarized below in Table 1:

TABLE 1
Order of Speech/Sign Development
Babbling - 6 months

(Manual babbling occurs here is sign language is accessible)
1^{st} True Word (spoken or signed) - 12-18 months
2^{nd} word utterance - 2 years old
3^{rd} word/developing grammar - 3 years old
Near to Adult Competency - 4 years old
Adult Competency (syntax) - 5 years old

As every child develops differently, the periods set above are approximations based on research. Therefore, with exposure to sign language, many children may enter the different stages earlier.

It is important to follow six basic concepts in early language development (Table 2).

TABLE 2
Six (6) Basic Concepts

1. Naming something (Label an object-Milk)
2. Addressing someone (Dad)
3. Finding something (Where book)
4. Something gone (No toy)
5. Asking for More (More juice/play again)
6. Possessing something (My chair)

These concepts are helpful for introducing signs. Some of the different embodiments developed for infants and children of different age groups and needs include, but are not limited to, Syllabus and Curriculum 1 (Table 3), Syllabus and Curriculum 2 (Table 4), Syllabus and Curriculum 3 (Table 5), Curriculum 4, Curriculum 5, Curriculum 6, Curriculum 7 and Curriculum 8.

TABLE 3
Syllabus and Curriculum 1

| | |
|---|---|
| 1. | Intros to each other; goals; class purpose and format week by week, |
| | session by session. |
| | Greetings: Hello/Goodbye, Good Morning, I Love You, How Are |
| | You/Fine... |
| | Songs: Good Morning, Hello and How Are You, Skinamarinkidink, |
| | See Ya Later Alligator |
| 2. | Review: Names: Mommy, Daddy, Baby, Grandparents, Brother/ |
| | Sister, Name, Family. |
| | Give Baby A Sign Name; Songs: The Name Game; Treasure Chest, |
| | Get Up and Dance! |
| 3. | Review: Favorite Foods/Things: Milk, Water, Juice Cookie, Sweet |
| | Potato, Apples, Bananas, Book, Toy, Music, Phone, Mirror, Bottle, |
| | Bath, Home, Shoe/Sock... |
| | Songs: You're Wanted on the Telephone, Apples & Bananas, Rubber/ |
| | Duckie: Who Stole the Cookie; “C” is for Cookie |
| 4. | Review: Practical Words: More/Again, Please/Thank You, Finished/ |
| | All gone, Yes/No, Up/Down, Toilet, Change, Wait, Sit, Want, Help, |
| | Delicious...’ |
| | Songs: The More We Get Together, The Noble Duke of York, Jack in |
| | the Box |
| 5. | Review: Things to Do: Eat, Sleep, Jump, Dance, Read, Play, Clap, |
| | Tickle... |
| | Songs: See How I'm Jumping, Are you Sleeping, Wiggle (Tickle), |
| | Clap Your Hands |
| 6. | Review: Words of Praise: Good, Smart, Proud, Wow |
| | Words of Caution: Hot, Don't Touch, Stop, Fire, Hurt, Share, Gentle, |
| | Dirty |
| | Extended Instrument Play - stop/go, up/down, sharing/turn taking; |
| | play the trumpet.. |
| 7. | Review: Feeling Words, Happy, Said, Tired, Angry, Scared, Excited, |
| | Pain/Hurt |
| | Songs: If You're Happy & You Know It, Feelings (Hap Palmer), |
| | It's Alright to Cry |
| 8. | Review: Manual Alphabet - ABC's, spelling names, etc. Complete |
| | Review, |
| | Questions/Comments, Request/Evaluation, Practical Applications, |
| | Introduction to Next Semester: Colors, Animals, stories in sign, ETC! |

TABLE 4
Syllabus and Curriculum 2

| | |
|---|---|
| 1. | Intro/Welcome back and Review through Favorite Songs: |
| | Skinamarinkidink, You're Wanted on the Telephone, The More We |
| | Get Together, See How I'm Jumping, If You're Happy & You Know |
| | It, ABCs. Requests and Instrument Play. |
| 2. | Review: Animals: Duck, Frog, Chicken, Dog, Cat, Bird, Horse, |
| | Pig, Sheep, Cow, Spider |
| | Songs: Wheels on the Bus, Down By the Station, Bicycle Built for |
| | Two, Row Your Boat |
| 3. | Review: Transportation: Car, Bike, Bus, Train, Airplane, Boat... |
| | Songs: Wheels on the Bus, Down by the Station, Bicycle Built for |
| | Two, Row Your Boat |
| 4. | Review: Colors: I Know the Colors of the Rainbow, I Can Sign A |
| | Rainbow, Me Gusta el Rojo, Los Colores; colored instrument play. |
| 5. | Review: Fingerspelling, Review: ABCs, The Name Game |
| 6. | Review: Signing while Reading Books & Storytelling |
| 7. | Review: Signs in Play & Activities of Daily Living (“ADLS”): |
| | Dressing, feeding, signing, games, shopping, walking in the park, |
| | making music! |
| 8. | Review: Question Words: Who, Where, What, Why... |
| | Songs: Where is Thumb kin, Peek-a-boo; Who Stole the Cookie, |
| | Hiding Games and songs. |
| | Complete Review, Questions/Comments/Requests/Evaluation, |
| | Practical Application. |
| | Introduction to Next Semester: Combining signs - develop more |
| | sophisticated language |

TABLE 5(a)
Syllabus and Curriculum 3

| | |
|---|---|
| 1. | Welcome Back: Review Question Words and Favorite Songs |
| 2. | Combining Signs: Location (Where), Recurrence (More/Again) |
| 3. | Combining Signs: Possession (Mine/Yours), Interrogation |
| | (Why/Where/What/How) |
| 4. | Combining Signs: Disappearance (All gone), Rejection (No), Denial |
| | (Not) |
| 5. | Combining Signs: Desire (I want/like), Attribution (Descriptive-i.e.: |
| | Dirty) |
| 6. | Combining Signs: Agent-Action, Action-Object, Agent-Object (who |
| | does what) |
| 7. | Combining Signs: Command, Notice-Existence (Greeting), |
| | Conjunction |
| 8. | Practice, Questions/Comments/Requests/Evaluation/Practical |
| | Applications. |
| | Integrating Sign Language and music into your life and family for |
| | the long term. |

TABLE 5 (b)
Curriculum 3

These two word utterances are typically expressed in speech or sign by:
age 18-24 months if hearing: age 2-3; if Deaf child of Deaf parents; age
4-5 if Deaf child of hearing parents

| Semantic Functions | Examples |
|---|---|
| Location | Cat Chair |
| Recurrence | More candy |
| Possession | Mike shirt |
| Interrogation | Where Mommy |
| Disappearance | Milk all-gone |
| Rejection | No bottle |
| Denial | Not Truck |
| Desire | Want Cookie |
| Attribution | Barbie Broke |
| Agent-Action | Daddy drive |
| Action-object | Eat banana |
| Agent-Object | Baby ('s) doll |
| Command | Go out |
| Notice/Existence | Hi Sally |
| Conjunction | Dog Cat |

Curriculum 4 comprises of sign language through music for parents and their babies at the preschool level as follows:

Sign Language through Music for Parents and their babies
Syllabus and Curriculum 4
Preschool Concepts

| | |
|---|---|
| 1. | Welcome back; Review |
| 2. | ABCs: Recognizing my name |
| 3. | Days of the Week |
| 4. | Seasons |
| 5. | Colors (review/more detail) |
| 6. | Same and Different (opposites, etc.) |
| 7. | Animals (review/more detail); Transportation (review/more detail) |
| 8. | Overall Review; prepare for level 5 |

Curriculum 5 comprises of sign language through music for parents and their babies at an advanced level using story, song and sign as follows:

Sign Language through Music for Parents and their babies
Syllabus and Curriculum 5
Story, Song, and Sign

| | |
|---|---|
| 1. | Chicka Chicka Boom Boom & the ABCs |
| 2. | Baby Beluga & water/sea animal signs |
| 3. | Twinkle Twinkle Little Star & related signs |
| 4. | The Itsy Bitsy Spider & related signs |
| 5. | Five Little Ducks & other animal/season signs |
| 6. | The Wheels on the Bus & other transportation signs |
| 7. | Your Favorite Songs and Stories |
| 8. | More of Your Favorites/Review |

Curriculum 6 includes Parent Workshops, adult education and family programs for individuals' age 18 and older during evenings or for families during weekends, the schedule comprising of the following activities:

Parent Workshops, Adult Education, and Family Programs
Ages 18 & Older (evenings): Families (weekends)
[Deaf and Hearing invited]

American Sign Language (ASL) Classes

Taught by Deaf teachers

Levels 1-5 basic training
Special courses in ASL for: preschool teachers; special ed.
Teachers; various educators; sales associates; medical
professionals; Taxi/bus drivers; actors;,...

Silent Weekends

ASL only; requires some experience with the language; Deaf and
hearing welcome

Family playgroups (socialize, eat, play, share
resources/experiences...)
High school student day (socialize, eat, play sports/games,
“gong show”...)
Teachers only
Siblings only
Doctors, Lawyers, Accountants, and other such
professionals
“Artists” only
Open weekend

Monthly workshops

Guest speakers or performers; Panel Discussions; Social Hours

Early childhood and elementary education options for my
Deaf child
My hearing child has a Deaf classmate...
My/My child's rights under the ADA and IDEA
The role of a school interpreter
College education and career opportunities for Deaf
individuals
Career counseling for Deaf adults
Cochlear implants and hearing aids
Living with a Deaf family member
Being a Deaf parent of hearing child(ren)
Being a hearing parent of Deaf child(ren)
Meeting hearing children of Deaf adults (CODAs)
Deaf children of hearing parents sharing experiences
ASL as a second language
How to use a TTY; What is a relay operator?
Performances by Deaf artists
Sample Baby Fingers classes
Story Time in Sign

Curriculum 7 includes after school programs for pre-K through 5^{th} grade and comprises of the following activities:

After School Programs
Pre-K through 5^{th} Grade (Deaf and Hearing Students)

Academic:

American Sign Language (ASL) classes
Tutoring in all subjects
Reading readiness
Writing skills (grammar, spelling, handwriting, creative
writing)

ASL and the Creative Arts:

Story telling and poetry
Puppetry
Drama
Dance
Drawing and painting
Music
Cooking

Curriculum Topics:

Family
Hobbies
School-individual experience as well as school subjects/
curriculum
Friends
Problem Solving/Conflict Resolution
Different cultures
Communication and self-expression
Values
When I grow up...
Colors, Days of the Week, ABCs and 1, 2, 3s (advanced
preschool concepts)
Nature
TTY, hearing aids, cochlear implants
Goals and fears
Animals; Foods; Transportation
Reading a map

Curriculum 8 includes additional programs comprising of drama, dance and other arts, in addition to the music and sign classes. The method of teaching varies, in that rather than utilizing music and songs as taught by the music therapist, the classes consist of creative expression, dance and movement, and tactile craft projects. Target vocabulary is maintained with adaptations as deemed appropriate for each group of students. The goals of the program comprise of enriching communication between parents and their children, accelerating language acquisition, improving spatial reasoning skills, enhancing speech development or supporting creativity.

Together, they discuss various applications or the sign of “more”, e.g. how to use the sign at dinner to ask for “more” food.

In such a gathering Mother L teaches new terms and signs and the collective learning approach fosters social skills and interactions between infants and toddlers and their caregivers. The caregivers sit in a circle around the room and the babies move about freely, babble and chat to one another and focus on the signing and Mother L's guitar playing.

It was found that some infants learned the signs with a matter of weeks and others took several months. The rate of development of sign language depends on age, motivation, amount of practice at hand. Sign language results in earlier ability to develop auditory language because motor skills in hands develop before oral skills. Signing let's children use words and syntax at an earlier age. Children who know sign language communicate better and are less frustrated.

The addition of music to sign language improves the attention and motivation of babies to learn signs and enhances their ability to read. This is partly because of cadences and phrases involved in reading and because reading and music are rhythmic activities.

### EXAMPLE 1

Baby 2 is one of a growing number of hearing children who are learning to communicate with the American Sign Language. Although most babies begin talking between one and two years, they understand and want to communicate much earlier.

Baby 2's mother, Mother L, started signing with him at birth so he would be able to express what he is unable to say. Mother L tested the system of the present invention in an experimental setting in which a number of hearing or deaf infants and their parents or caretakers attended. The participants sign songs, and learn signs for everyday communication, such as greetings, names and practical word, e.g. to teach the sign for the term “more” Mother L and the group sign the song “The More We Get Together”. They also practice the sign for “more” using their hands.

### EXAMPLE 2

As an embodiment of Level 1 curriculum video lyrics have been developed as follows:

### Baby Fingers LLC˜˜˜Level 1 Video Lyrics

### “Good Night Ladies”

Good morning Mommy, good morning Daddy, good morning Baby, good morning to You.

Good afternoon, good afternoon, good afternoon, so nice to see you!.

Good night Grandma, good nigh Grandpa, good night Baby, god night to You.

(Repeat)

### “Are You Sleeping”

Are you sleeping, are you sleeping Baby (Zeke), Baby (______)?.

Are you sleeping, are you sleeping? Go to sleep, go to sleep . . . (Repeat).

Are you eating, are you eating, eating (peas), eating (peas)?.

Are you eating (carrots) are you eating (carrots)? Time to eat, time to eat . . .

(Repeat—add different foods: cheese, crackers; drinking milk, water).

How are you feeling, how are you feeling? Feeling (sad), feeling (sad)?.

How are you feeling, how are you feeling? Feeling (sad), feeling (sad)?.

(Repeat—add different emotions: angry, happy).

### “The More We Get Together”

The more we get together, together, together . . . the more we get together the happier we'll be.

For your friends are my friends and my friends are your friends.

The more we get together the happier we'll be!.

The more we play together, together, together . . . the more we play together the happier we'll be.

Mommy and Daddy, playing ball with Baby . . . the more we play together the happier we'll be!.

The more we read together, together, together . . . the more we read together the happier we'll be.

Mommy and Daddy, reading books with Baby . . . the more we read together the happier we'll be!.

“The Alphabet Song”

A B C D E F G...H I J K L M N O P..Q R S..T U V...WXY and Z

Now I know my ABCs.

Next time won't you sing with me!.

### All Songs Traditional

“Good Night Ladies,” “Are You Sleeping,” and “The More We Get Together” with additional lyrics by Lora F. Heller; c Baby Fingers LLC 2000.

Vocalist, Teacher, Signer: Lora F. Heller: Pianist Nina Guerrero; Producer: Ian Lowell Heller.

### EXAMPLE 3

As an embodiment of Level 2 curriculum video lyrics have been developed as follows:

### Baby Fingers LLC˜˜˜Level 2 Video Lyrics

### “Old MacDonald”

Old MacDonald had a farm, E-I-E-I-O.

And on that farm he had a (cow), E-I-E-I-O.

With a (moo, moo) here and a (moo, moo) there; Here a (moo) there a (moo)

Everywhere a (moo, moo)

Old MacDonald had a farm, E-l-E-I-O.

(Repeat—horse/neigh; pig/oink; dog/woof; cat/meow; sheep/baa; rooster/cock-a-doodle-doo).

### “Row, Row, Row Your Boat”

Row, row, row your boat . . . gently down the stream.

Merrily, merrily, merrily, merrily . . . life is but a dream.

(Repeat).

### “The Wheels on the Bus”

The wheels on the bus go round and round, round and round, round and round.

The wheels on the bus go round and round . . . all over town.

The doors on the bus go open and shut, open and shut, open and shut.

The doors on the buys go open and shut . . . all over town.

The people on the bus go up and down, up and down, up and down.

The people on the bus go up and down . . . all over town.

(Repeat)

### “Los Colores”

Blanco, Negro, rojo, azul . . . learn my colors when I go to school.

White, black, red and blue . . . I know my colors and so do you!.

Voy a la escuela para aprender, me gusta la escuela! Yes, I like it there!

Verde, naranja, Amarillo, morado . . . before I came to school there were some things I didn't know.

Green, orange, yellow, purple too . . . know my colors and so do you!

Voy a la escuela para aprender; me gusta la escuela! Yes, I like it there!

Now I know my colors, los colores—si, yo se!

Yes now I know my colors, los colors . . . Hurray!

### First Three Songs Traditional

“Los Colores” music and lyrics by Lora F. Heller; c L. F. Heller 1996. Vocalist, Teacher, Signer: Lora F. Heller; Pianist; Nina Guerrero; Producer: Ian Lowell Heller

### EXAMPLE 4

Another embodiment of the present invention comprises of a clothing line including T-shirts, bibs, pajamas, jackets, hats, shoes, or blankets. One specific example is painting or embroidering an apple, the word apple and the sign for an apple.

### EXAMPLE 5

An additional embodiment of the present invention comprises of story books and picture books such as “touch and feel” and/or “lift the flap: books. Commonly asked questions are summarized in the following FAQs sheet.

FAQs

Question 1: Will signing with my baby delay her speech development?

Answer: Research clearly indicates that babies who sign tend to have a stronger command of verbal language and also begin speaking at an earlier age than babies who don't sign.

Question 2: Why are Baby Fingers classes based on American Sign Language?

Answer: As Joseph Garcia stated regarding Sign with Your Baby programs: Since the birth of the United States, ASL has been evolving to become the accepted sign language in North America. It is now standardized throughout the United States and Canada. The advantage of using a standardized sign language as a foundation is that most people who share knowledge of that language will be able to identify and respond to the signs that your baby knows.

ASL structure is compatible with the nature of language development in infants. One sign can relate an entire concept. Young children begin communicating using one-word sentences (or in this case, one-gesture sentences) to express complete thoughts or needs.

ASL signs are also very iconic, in many cases resembling the objects or activities they represent. A foundation is provided for continued learning of ASL in later years.

Question 3: Are classes only for Deaf children?

Answer: No, Baby Fingers was developed for hearing babies and hearing parents. However, Deaf children and children with a variety of special needs will benefit from the program.

Question 4: What is the optimal age to introduce signs to our child?

Answer: I suggest you being learning the signs anytime. Some babies may being to sign as early as 4-6 months, other not until after a year, depending on consistency of use at home. A baby needs to develop memory, dexterity, and cognition adequate for recognizing, retaining, and producing signs. It is never too late to start. Baby Fingers classes include children ages one month through five years.

Question 5: How long will it take for our baby to start signing?

Answer: This also depends upon use at home. Integrating sign into your daily activity and consistently using signs on a daily basis is the key. Your child's age and motivation also play a role; some will start signing in a week, others in a few months. Older children may learn and integrate signs immediately, and will benefit from the social aspects of learning sign language, awareness and understanding of other cultures and individual differences, improved communication and self expression, refined reading skills, self esteem.

Question 6: What scientific research supports the idea of signing with babies?

Answer: Research in this area is continuing today at Ohio State University, see the follows: http://www.newswise.com/articles/1999/1/SIGNLANG.OSU.html. A recently released longitudinal study was conducted at the University of California at Davis by Drs. Linda Acredolo and Susan Goodwyn. The study, which followed babies through their eighth year, indicated that signing with babies has many benefits including a strengthened parent-child bond, increased interest in books, enhanced verbal language development and higher IQS.

Question 7: Why the combination of music and sign language?

Answer: Music also enhances language development, spatial reasoning skills, socialization, and motivation to communicate. Signing is rhythmic as is music, and the combination provides a natural means by which to practice and interact.

### EXAMPLE 6

Yet another embodiment of the present invention comprises of toys and/or games, such as bingo games, puppets, dolls or stuffed toys, or battery operated “see, say sign and sing” samples.

### EXAMPLE 7

A preferred embodiment of the intervention comprises of a children's television show which emphasizes the importance of education and entertainment, of teaching the American Sign Language (ASL) through signs, songs or dramatic play, of emphasizing communication, language, speech development and reading skills, of exposing children to the arts and/or of providing quality programming for all families and including a signed show for the deaf.

The present invention is not to be limited in scope by the embodiments disclosed in the example which are intended as an illustration of some aspects of the invention and any methods and devices which are functionally equivalent are within the scope of the invention. Indeed, various modifications of the invention in addition to those shown and described herein will become apparent to those skilled in the art from the foregoing description. Such modifications are intended to fall within the scope of the appended claims.

What is claimed is:

1. A system for enhancing language communication in infants and children, said system comprising:
a plurality of curricula suitably developed for different ages of the infants and children,
a set of songs selected for teaching terms that are also expressed by sign language,
a set of reading and graphic materials and
A collection of music that provides a steady and rhythmic beat.

2. The system according to claim 1 comprising:
a level one basic language acquisition program,
a level two comprising of introductory preschool concepts,
a level three comprising of semantic functions,
a level for comprising of advanced preschool concepts, and
a level five comprising of story, song and sign.

3. The system according to claim 2, further comprising of a clothing line selected from the group consisting of T-shirts, bibs, pajamas, jackets, hats, shoes and blankets, to enhance learning and communication in babies.

4. The system according to claim 1, further comprising of books consisting essentially of story books or picture books, to promote learning in babies through “touch and feel” or “lift the flap” methods.

5. The system according to claim 1, further comprising of toys, games or battery-operated gadgets to promote instruction by “see, say, sign and sing” methods.

6. The system according to claim 1 further comprising of a children's television show to enhance teaching of ASL and learning in babies.

7. A method of enhancing language communication in infants and children, said method comprising the steps of:
Teaching sign language,
Teaching creative arts language,
Playing music at a rhythmic beat, and combining singing songs to support the terms learned by sign language.

8. The system according to claim 1 comprising:
a level one basic language acquisition program,
a level two comprising of introductory preschool concepts,
a level three comprising of semantic functions,
a level for comprising of advanced preschool concepts, and
a level five comprising of story, song and sign.

9. A method according to claim 2, further comprising of a clothing line selected from the group consisting of T-shirts, bibs, pajamas, jackets, hats, shoes and blankets, to enhance learning and communication in babies.

10. The system according to claim 1, further comprising of books consisting essentially of story books or picture books, to promote learning in babies through “touch and feel” or “lift the flap” methods.

11. The system according to claim 1, further comprising of toys, games or battery-operated gadgets to promote instruction by “see, say, sign and sing” methods.

12. The system according to claim 1 further comprising of a children's television show to enhance teaching of ASL and learning in babies.
